(19) United States
(12) Patent Application Publication
(10) Pub. No.: US 2025/0270398 A1
(43) Pub. Date: Aug. 28, 2025

(54) MAGNETIC SLIMEBOT, COMPOSITION FOR ITS MANUFACTURE AND USES THEREOF

(71) Applicant: MULTI-SCALE MEDICAL ROBOTICS CENTER LIMITED, Hong Kong (CN)

(72) Inventors: Mengmeng SUN, Hong Kong (CN); Wai Yan Philip CHIU, Hong Kong (CN); Li ZHANG, Hong Kong (CN)

(21) Appl. No.: 18/858,403

(22) PCT Filed: Apr. 21, 2023
(86) PCT No.: PCT/IB2023/054066

§ 371 Date: Oct. 21, 2024

Related U.S. Application Data
(60) Provisional application No. 63/333,518, filed on Apr. 21, 2022.

(51) Int. Cl. C08L 29/04; A61K 9/06; C08K 3/11; C08K 3/22; C08K 3/32; C08K 3/38; C08K 9/02

(52) U.S. Cl. CPC C08L 29/04; A61K 9/06; C08K 3/11; C08K 3/22; C08K 3/38; C08K 9/02; C08K 2003/321; C08K 2003/387; C08K 2201/01; C08L 2312/00

(57) ABSTRACT

This invention provides a multifunctional magnetic composition that can be used in applications such as slimebots and sensors. In one embodiment, said composition, comprises: a) 0.005-5 wt. % of a source of tetrafunctional borate ions; b) a buffer for maintaining pH at 6.5 to 9.5; c) 0.005-80 wt. % of magnetic particles; and d) a polymeric glue having hydroxyl groups; wherein said tetrafunctional borate ion, buffer and magnetic particles are crosslinked in said polymeric glue to form a non-Newtonian fluid composition.

### FIELD OF THE INVENTION

This invention relates to small-scale soft robots.

### BACKGROUND OF THE INVENTION

Miniature robots that respond to external stimuli have the advantage of being less invasive and more accessible, making them exciting candidates for biomedical applications such as targeted drug delivery, minimally invasive surgery, and cell transplantation. Owing to its safety, precision, and fast response, an external magnetic field is a promising choice for actuating small-scale robots. Thus far, most magnetically actuated soft-bodied robots have been fabricated from soft elastomers mixed with hard magnetic particles. Such elastomer-based soft robots perform multiple movement modes, adapt to complex interface environments, and enter confined spaces for robotic manipulation applications. However, the functionality of elastomer-based soft robots is limited by their predesigned shapes and cannot be reconfigured in situ. Moreover, elastomer-based soft robots possess limited deformation capabilities and cannot pass through narrow spaces that are significantly smaller than their dimensions.

In contrast, recent studies have demonstrated that small fluid-based robots, such as those based on liquid metal or ferrofluid, behave more gently and softly. Fluid-based soft robots exhibit better deformability than elastomer-based soft robots owing to their fluid flow properties that allow them to easily pass through extraordinarily narrow and restricted spaces and avoid damaging surrounding biological tissues. For instance, by constructing an electromagnet array, an intelligent deformable and cooperative ferrofluid-based soft robot that could pass through 1.5 mm diameter narrow channels and perform various functions was constructed. In addition, researchers have also realized the control of electric circuits and fluid pumping using liquid-metal-based soft robots. However, ferrofluid-and liquid metal-based robots require very demanding operating environments; for instance, oil-based ferrofluids require hydrophilic surfaces surrounded by water-based solutions to maintain the shape of the spherical droplets without adhering to the substrate, whereas liquid metals require alkaline or acidic solutions to preserve the form of spherical droplets without adhering to the substrate. Therefore, it is necessary to combine the characteristics of large deformations of liquid-based robots with the complex interface adaptability of elastomer-based robots to create novel soft robots.

### SUMMARY OF THE INVENTION

This invention provides a multifunctional magnetic composition. In one embodiment, said composition, comprises: a) 0.005-5 wt. % of a source of tetrafunctional borate ions; b) a buffer for maintaining pH at 6.5 to 9.5; c) 0.005-80 wt. % of magnetic particles; and d) a polymeric glue having hydroxyl groups; wherein said tetrafunctional borate ion, buffer and magnetic particles are crosslinked in said polymeric glue to form a non-Newtonian fluid composition.

This invention also provides a slimebot comprising the composition of this invention.

This invention further provides a system comprising a) one or more said slimebot of this invention; and b) one or more magnetic field generator.

This invention also provides a sensor comprising the composition of this invention. In one embodiment, said sensor measures changes in electrical properties of said composition in response to one or more mechanical stimulus.

This invention further provides a device comprising the composition of this invention. In one embodiment, said composition is used for controlling electrical conductivity in a part of an electrical circuit.

This invention further provides a method of using the composition of this invention to achieve a function. In one embodiment, said method comprises the steps of: a) providing said composition to a location where said function is to be achieved; b) subjecting said composition to a magnetic field; c) controlling said magnetic field to direct movement of said composition.

### BRIEF DESCRIPTION OF THE FIGURES

Illustrative aspects of the present disclosure are described in detail below with reference to the following drawing figures. It is intended that that embodiments and figures disclosed herein are to be considered illustrative rather than restrictive. Like reference symbols and designations in the various drawings indicate like elements.

FIG. 1 shows schematic description of the properties and application scenarios of magnetic slimebots.

FIG. 2 shows the schematic diagram of the preparation of the magnetic slimebot and its physical image and scanning electron microscope image.

FIG. 3 shows the viscoelasticity of the magnetic slimebot.

FIG. 4 shows the in vitro cytotoxicity of the magnetic slimebot.

FIG. 5 shows the active and passive deformability of the magnetic slimebot.

FIG. 6 shows the deformability of the magnetic slimebot vs. the content of inner

magnetic particles, the deformability of the magnetic slimebot vs. the strength of the permanent magnet, and the minimum diameter of the magnetic slimebot that can pass through the thin tube vs. the magnetic field strength.

FIG. 7 shows a comparison of the deformation capabilities of magnetic slimebot, ferrofluid droplet robot and liquid metal robot.

FIG. 8 is sequential snapshot of videos showing that the magnetic slimebot is actuated to navigate through the channel, tube, maze, and uneven surfaces in air.

FIG. 9 is the stability test of magnetic slimebot underwater.

FIG. 10 shows the processes of magnetic slimebot traversing the narrow passage underwater.

FIG. 11 is the adhesion property test of magnetic slimebot.

FIG. 12 shows overlapped sequential snapshots of videos demonstrating that the magnetic slimebot is actuated along the “S”, “L”, “I”, “M”, “E”, “B”, “O”, and “T” trajectories on varying substrate surfaces in air.

FIG. 13 is the magnetic-actuation systems for magnetic slimebot.

FIG. 14 shows the magnetic slimebot grasps a single target object (above) and multiple target objects (below) in curling mode.

FIG. 15 shows the magnetic slimebot grasps target objects in open environment (above) and complex restricted environment (below) in endocytosis mode.

FIG. 16 shows two button batteries (naked and wrapped with slimebot) were placed between the inner walls of the intestine.

FIG. 17 shows the manipulation process of the magnetic slimebot within crescent mode.

FIG. 18 is the self-healing analysis of the magnetic slimebot.

FIG. 19 shows that magnetic slimebot can act as circuit switches or be used to repair circuits.

FIG. 20 shows the relative resistance of the magnetic slimebot vs. the strain, the relative resistance of the magnetic slimebot vs. the bending angle, and the relative resistance of the magnetic slimebot vs. the twist angle.

FIG. 21 shows the magnetic slimebot can be used to monitor human movement.

### DETAILED DESCRIPTION OF THE INVENTION

Disclosed are materials, devices, methods, and systems for multifunctional magnetic slimebot. The magnetic slimebot may include hydrogel and magnetic materials. The device of the magnetic slimebot includes a magnetic drive system composed of a non-Newtonian fluid slime robot body and a three-axis robotic arm. The method can comprise: a method for active and passive deformation of a magnetic slimebot; a method for generating a curling behavior of the magnetic slimebot; a control strategy for generating an endocytosis mode for the magnetic slimebot. A manipulation system based on the magnetic slimebot can be used to grasp foreign objects in living organisms and can be used for circuit repair.

Embodiments of the present invention relates to materials, devices, methods, and systems for preparing and driving multifunctional magnetic slimebot. Magnetic slimebots can be prepared based on magnetic particles with viscoelastic hydrogels. The present invention includes the magnetic field generating device that drives the locomotion of the magnetic slimebot. The present invention includes methods for driving magnetic slimebot to develop curling behavior and endocytosis behavior. Furthermore, the present invention relates to all the materials, devices, and systems that are designed for multifunctional magnetic slimebot.

In one aspect, the present invention provides a magnetic slimebot with large deformations and adaptability. Existing elastomer-based soft robots possess good environmental adaptability, and liquid-based soft robots possess large deformation characteristics. The magnetic slimebot combines the characteristics of large deformation with environmental adaptability. In comparison with existing elastomer-based soft robots, our proposed slime robot has better deformability, for instance, through narrow pipes (1.5 mm) and complex maze environments. In addition, when compared to existing fluid-based soft robots, the slime robot has greater environmental adaptability, allowing movement not only in two-phase fluids but also in air, and even on various surfaces such as hydrogel, metallic, and plastic surfaces.

In another aspect, the present invention provides a magnetic slimebot with multiple functions. The magnetic slimebot is reconfigurable, self-healing and electrically conductive, and thus has multiple functions. In embodiments, this slimebot can have multiple reconfigurable functions, such as grasping and delivering objects through the curling mode and wrapping and transporting harmful things through the endocytosis mode. In addition, the ability to self-heal and conduct electricity allows the slimebot to be used as an electrical device, for instance, as a piezoresistive strain sensor to monitor human movement and as a circuit control switch or circuit breaker repair agent. This proposed magnetic slimebot with a large deformation, reconfigurability, self-healing, and conductivity is expected to be of great value in wearable devices and biomedical applications.

This proposed magnetic slimebot with a large deformation, reconfigurability, self-healing, and conductivity is expected to be of great value in wearable devices and biomedical applications, such as targeted drug delivery, minimally invasive surgery. The details of one or more embodiments of the invention are set forth in the accompanying drawings and the description below. Other features, objects, and advantages of the invention will be apparent from the drawings and detailed description, and from the claims.

This invention provides a multifunctional magnetic slimebot. In one embodiment, said multifunctional magnetic slimebot comprises: a borate ion containing/liberating compound, solution, or salt present in an amount of from about 0.005 percent, by weight, to about 5 percent, by weight; and a buffer present in an amount effective to maintain a pH of the composition in a range of from about 6.5 to about 9.5; and magnetic particles present in an amount of from about 0.005 percent, by weight, to about 80 percent, by weight; wherein the slimebot is configured to crosslink with a polyvinyl alcohol-based glue, or other polymeric glue/adhesive and thereby form a magnetic slimebot composition; directing a magnetic slimebot to the site in need of treatment in the gastrointestinal tract of a patient by subjecting it to an external stimulus, where the external stimulus is outside the patient's body, and where the slime robot can spread, curl and grasp; driving the slimebot to reach the restricted environment that is difficult for traditional robotic arms and humans to reach, and realizing the repair of broken parts of the circuit; encapsulating the magnetic slimebot to act as a piezoresistive sensor for wearable devices.

In one embodiment, the slimebot comprises a borate ion containing/liberating compound, solution, or salt and the borate ion containing/liberating compound, solution, or salt is boric acid, sodium borate, sodium tetraborate, disodium tetraborate, sodium tetraborate decahydrate, or any combinations thereof.

In one embodiment, the borate ion containing/liberating compound, solution, or salt is present in an amount of from about 0.005 percent, by weight, to about 0.5 percent, by weight.

In one embodiment, a polyvinyl acetate-based glue/adhesive or a polyvinyl alcohol-based glue/adhesive or another polymeric based glue/adhesive of appropriate functionality for crosslinking (suitable for all molecular weights).

In one embodiment, the slimebot comprises magnetic particles, such as NdFeB, nickel, iron and their oxides, other magnetic metallic oxides, or any combinations thereof.

In one embodiment, the magnetic particles are present in an amount of from about 0.005 percent, by weight, to about 80 percent, by weight.

In one embodiment, the magnetic particles are present in an amount of from about 0.005 percent, by weight, to about 80 percent, by weight.

This invention also provides a method of making a slimebot composition. In one embodiment, said method comprises: combining the borate ion containing/liberating compound, magnetic particles, with a polyvinyl alcohol-based glue/adhesive or another polymeric based glue/adhesive of appropriate functionality for crosslinking.

This invention also provides a system for driving the magnetic slimebot of this invention. In one embodiment, the system comprises: the plurality of steerable magnetic slimebots; a magnetic field generator configured to steer the plurality of magnetic slimebots with a magnetic field.

This invention further provides a method of treatment using the multifunctional magnetic slimebot of this invention. In one embodiment, said method comprises the steps of: i) delivering said multifunctional magnetic slimebot into a gastrointestinal tract of a patient by an endoscope; ii) causing said multifunctional magnetic slimebot to an operable position within the gastrointestinal tract by the external stimulus; and iii) guiding said multifunctional magnetic slimebot to a site requiring treatment in the gastrointestinal tract by X-ray fluoroscopy imaging.

In one embodiment, the site requiring treatment comprises debris or swallowed foreign body in the gastrointestinal tract.

In one embodiment, directing the magnetic slimebot to the site requiring treatment comprises manipulating the slimebot with one or more external magnetic fields.

This invention also provides a method of circuit repair using the multifunctional magnetic slimebot of this invention. In one embodiment, comprising: delivering a magnetic slimebot into the restricted location; controlling the magnetic slimebot to curl by the external magnetic field.

In one embodiment, the restricted location comprises environment with or without gravity or with or without radiation.

This invention also provides a method of motion monitor using the multifunctional magnetic slimebot of this invention. In one embodiment, said method comprises: encapsulating magnetic slimebot in tape as piezoresistive sensors; adhering piezoresistive sensors to moving parts.

This invention also provides a method of biofilm removal using the multifunctional magnetic slimebot of this invention. In one embodiment, said method comprises: slimerobots are modified with antimicrobial agents and then arranged to the location of the biofilm and the biofilm is mechanically scraped using the slimerobots.

This invention also provides a method of cleaning ultra-precise instruments using the multifunctional magnetic slimebot of this invention. In one embodiment, said method comprises: driving the slimerobots inside the instruments and use the stickiness to remove dust or other dirt.

This invention provides a multifunctional magnetic composition. In one embodiment, said composition, comprises: a) 0.005-5 wt. % of a source of tetrafunctional borate ions; b) a buffer for maintaining pH at 6.5 to 9.5; c) 0.005-80 wt. % of magnetic particles; and d) a polymeric glue having hydroxyl groups; wherein said tetrafunctional borate ion, buffer and magnetic particles are crosslinked in said polymeric glue to form a non-Newtonian fluid composition.

In one embodiment, said source of tetrafunctional borate ions comprises one or more selected from the group consisting of boric acid, sodium borate, disodium tetraborate, sodium tetraborate decahydrate and sodium tetraborate.

In one embodiment, said buffer comprises deionized water or phosphate buffered saline.

In one embodiment, said magnetic particles are: a) metallic oxide particles; b) NdFeB particles; or c) coated with SiO₂.

In one embodiment, said polymeric glue is polyvinyl alcohol. In another embodiment, said polyvinyl alcohol comprises one or more selected from the group consisting of PVA 07-18, PVA 07-19, PVA 08-08 and PVA 08-18.

This invention also provides a slimebot comprising the composition of this invention.

This invention further provides a system comprising a) one or more said slimebot of this invention; and b) one or more magnetic field generator.

In one embodiment, said one or more magnetic field generator comprises a robotic arm, a stepper motor and a permanent magnet, wherein said stepper motor is located at the end of said robotic arm and adjusts speed and direction of said permanent magnet.

In one embodiment, said permanent magnet is a spherical magnet.

This invention also provides a sensor comprising the composition of this invention. In one embodiment, said sensor measures changes in electrical properties of said composition in response to one or more mechanical stimulus.

In one embodiment, said electrical properties comprise one or more of impedance or resistance.

In one embodiment, said one or more mechanical stimulus comprise one or more of stretching, bending or twisting.

This invention further provides a device comprising the composition of this invention. In one embodiment, said composition is used for controlling electrical conductivity in a part of an electrical circuit.

In one embodiment, said part is: a) an electrical switch or a resistor; or b) a damaged part.

This invention further provides a method of using the composition of this invention to achieve a function. In one embodiment, said method comprises the steps of: a) providing said composition to a location where said function is to be achieved; b) subjecting said composition to a magnetic field; and c) controlling said magnetic field to direct movement of said composition.

In one embodiment, said function comprises one or more of: a) removing biofilms; b) cleaning of ultra-precise instruments; c) repairing electrical circuits; or d) retrieving one or more objects in a cavity.

In one embodiment, said one or more objects is an ingested foreign body and said cavity is a gastrointestinal tract.

In one embodiment, said movement comprises grasping, wrapping, spreading, curling or endocytosis.

In one embodiment, said location is: a) an environment with or without gravity; or b) an environment with or without radiation.

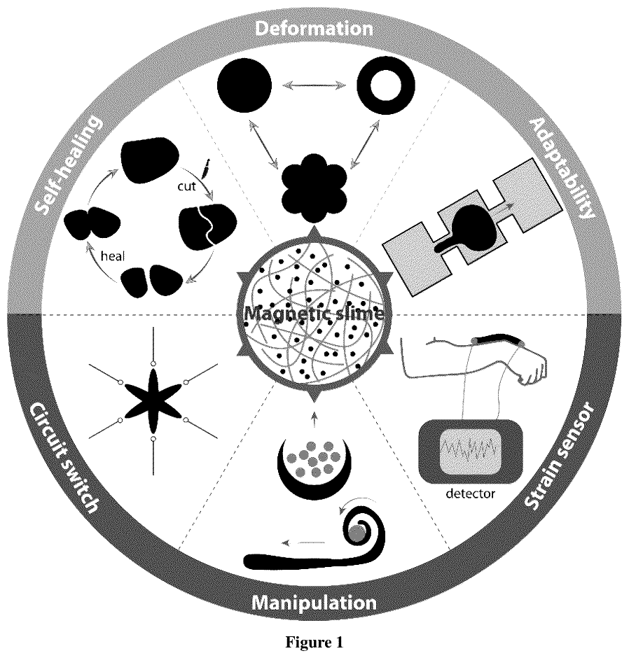

The present invention may be understood more easily by reference to the detailed description, which forms a part of this disclosure. This invention is not limited to the specific materials, devices, methods, or systems described and/or shown herein. Unless otherwise defined, all technical and scientific terms used herein have the same meaning as commonly understood by one of ordinary skill in the art to which this invention belongs. Although materials, devices, methods, and systems similar or equivalent to those described herein can be used in the practice or testing of the present invention, suitable methods and materials are described below. The present invention describes specific embodiments of magnetic slimebot, including preparation methods, driving systems, and various potential application scenarios (FIG. 1).

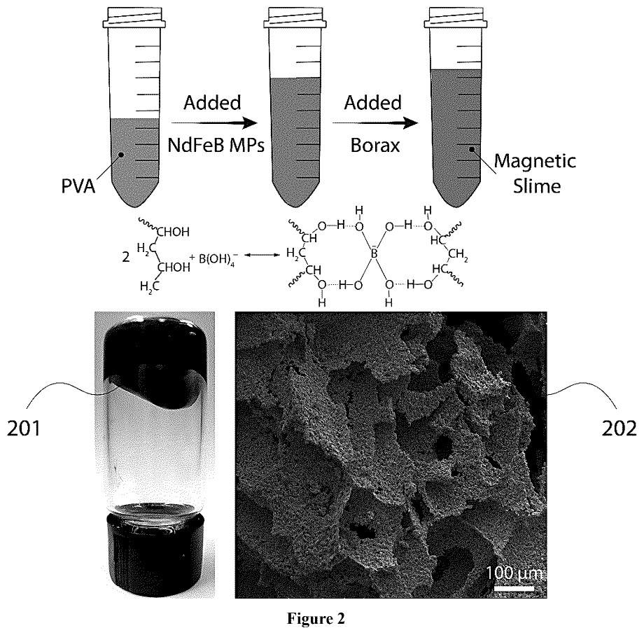

The preparation scheme of the disclosed magnetic slimebot is illustrated in FIG. 2, where magnetic particles (NdFeB) and borax were sequentially added to a polyvinyl alcohol (PVA) solution to obtain the magnetic slimebot. The magnetic particles can be extended to other magnetic particles such as nickel, iron and their oxides, and other magnetic metallic oxides. The inset shows the critical reactions necessary for the formation of the magnetic slimebot 201. Magnetic slimebot is formed primarily through the interaction of tetrafunctional borate ions with the —OH group of PVA, where tetrafunctional borate ions are generated through the hydrolysis of borax. Notably, magnetic slimebot consists of >90 wt % water, implying that it is essentially a hydrogel. Scanning electron microscopy (SEM) image 202 indicates that the microstructure of the magnetic slime is a three-dimensional (3D) porous network of magnetic particles cross-linked with immobilized polymers. The porous structure is favorable for the extensibility and fast response of the magnetic slimebot.

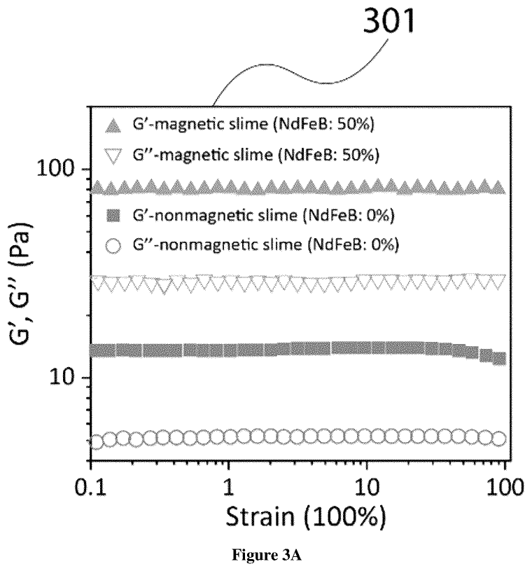

In order to evaluate the rheological and magnetorheological properties of the disclosed slimebot (FIG. 3), the rheometer (Anton Paar MCR302) with a 25 mm parallel plate setup was used. A dynamic strain sweep ranging from 0.1 to 100% at ω=10.0 Hz was first performed, and the storage modulus (G′) 301 was recorded to define the linear viscoelastic region (LVR) in which the storage modulus is independent of the strain amplitude. A strain of 1.0% was selected in subsequent oscillation tests to ensure that the dynamic oscillatory deformation of each sample was within the LVR. 302 shows the changes in the storage (G′, solid symbols) and loss moduli (G″, hollow symbols) as a function of angular frequency for non-magnetic slime (NdFeB: 0%) and magnetic slime (NdFeB: 50%). Both slimebots are in a solid state, with the storage modulus exceeding the loss modulus over the entire frequency range. It is observed that the presence of NdFeB microparticles raises the moduli and enhances the elastic response of the slimebot. In addition, 303 shows the dependence of G′ on the magnetic field at a fixed strain amplitude (0.2%) and angular frequency (6 rad/s). The change in storage modulus for the magnetic slimebot is significant in increasing the magnetic field strength, indicating a significant magnetorheological effect. Applying a magnetic field enhances the mechanical properties of the magnetic slimebot owing to the magnetic dipole-dipole forces. Magnetic-field-dependent dynamic viscoelasticity is mainly attributed to the interaction between adjacent particles when they are magnetized. Such interactions condense the polymer chain and make the structure more rigid. The magnetorheological effect causes magnetic slimebot to exhibit tunable stiffness by applying a magnetic field. Therefore, it is possible to control the stiffness of the magnetic slimebot to adapt it to different working environments.

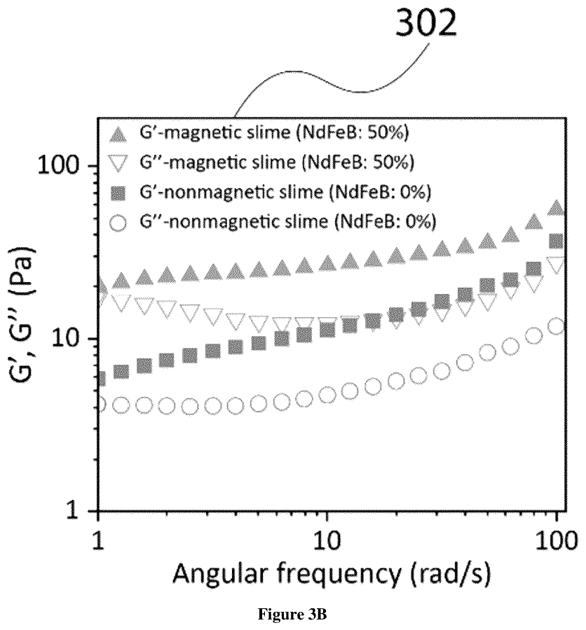

In order to evaluate the cytotoxicity of the disclosed slimebot, NIH 3T3 cells with a density of 2000 cells/well were seeded in a 96-well plate, followed by 12 h incubation in 100 μL Eagle's Minimum Essential Medium with 10% fetal bovine serum. As shown in FIG. 4, at concentrations up to 400 μg/mL, non-magnetic slime material is nontoxic to NIH 3T3 cells, indicating its excellent biocompatibility. However, NdFeB particles are toxic, thus making the magnetic slimebot (NdFeB: 30%) non-biocompatible. Therefore, the NdFeB microparticles were coated with SiO₂. Transmission electron microscopy images demonstrated that the NdFeB microparticles were coated with a layer of 35 nm SiO₂. Subsequently, they were added to the PVA solution to prepare the magnetic slimebot. Cytotoxicity tests showed that the 400 μg/mL magnetic slimebot prepared using NdFeB@SiO₂ 401 were not toxic to cells.

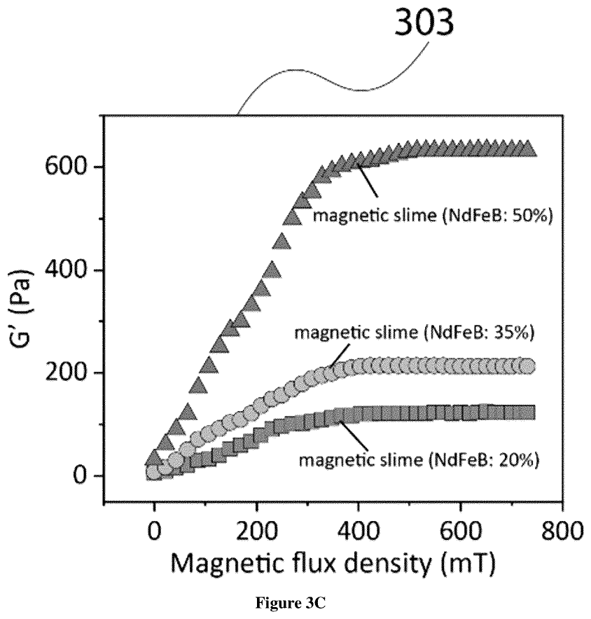

In embodiments, the magnetic slimebot can deform into complex shapes, such as circles, hexagons, and rings, under the configured magnetic field. The morphology of the magnetic slimebot is similar to that of the permanent magnet 501 at the bottom because the unmagnetized magnetic particles in the slime tend to move to the position with the lowest magnetic field strength. This allows the magnetic slimebot to change its morphology depending on the needs of different tasks. FIG. 5 shows that the magnetic slimebot can be driven by a permanent magnet 502 and stretched more than seven times its original length along the direction of the magnet motion. At t=0 s, a magnetic slimebot with a diameter of 9 mm was placed on a polymethylmethacrylate substrate, and a circular permanent magnet with a diameter of 20 mm and height of 10 mm was set at 4 mm below the substrate. As the circular permanent magnet moved at a speed of 2 mm/s, the slimebot started to elongate and stretched to 60 mm after 71 s.

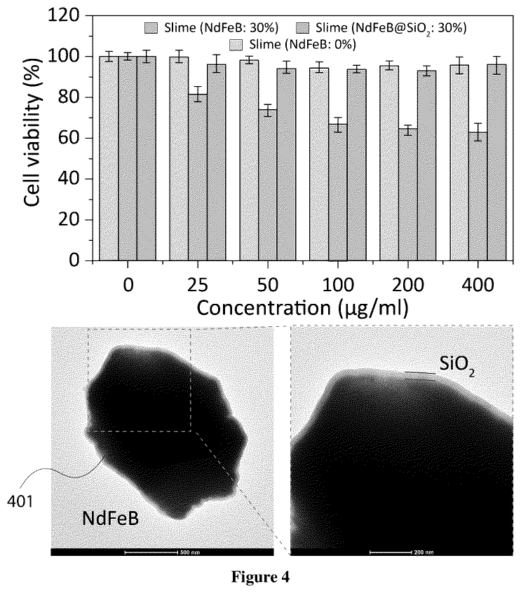

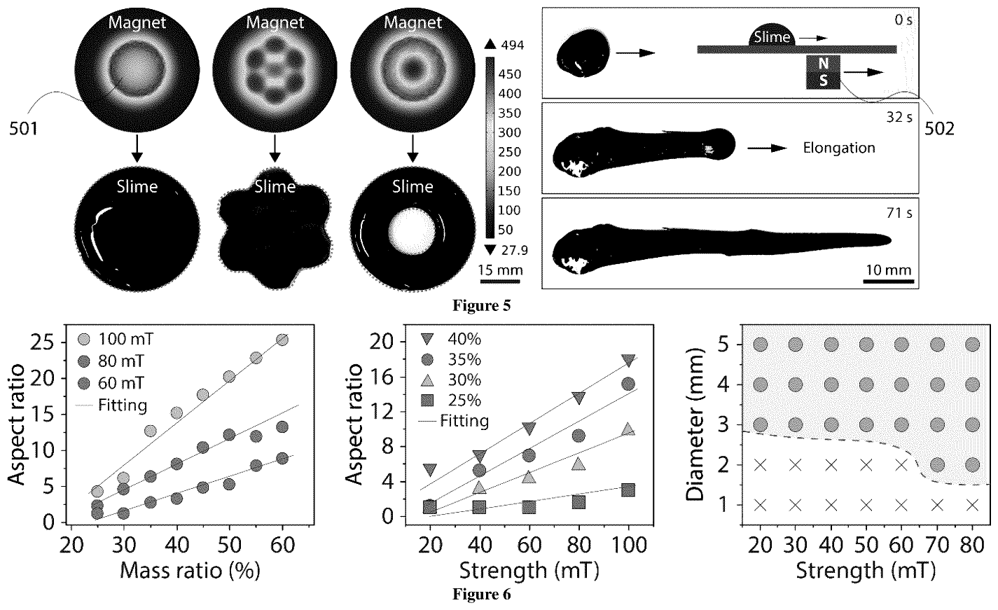

To achieve optimally controlled deformation of the magnetic slimebot, the aspect ratio of slimebot when varying the content of magnetic particles and the strength of the applied magnetic field was carefully investigated. As shown in FIG. 6, the aspect ratio of the magnetic slimebot deformation is proportional to the magnetic particle content when the applied magnetic field is the same. Under an external magnetic field, the increase in the magnetic powder content dramatically enhances the magnetic response of the slimebot, causing it to be subjected to a more significant deformation force. In addition to the magnetic particle content, the outer magnetic field strength also affects the deformation behavior of the magnetic slime. The deformation ability of the magnetic slimebot is positively correlated with the strength of the external magnetic field. The motion behavior of the internal particles of the slimebot is determined by the magnetic field strength that affects its overall deformation properties. To characterize the mobility of the magnetic slimebot in a restricted environment, the minimum diameter of the tube through which the slimebot could pass was investigated. The experimental results demonstrate that the minimum diameter of the channel through which the slimebot can pass is 1.5 mm for a fixed content of magnetic particles and slime volume. The minimum diameter of the tube through which it can pass increases as the external magnetic field strength decreases. The deformability of ferrofluid droplet, magnetic liquid metal, and magnetic slime robots under equal magnetic field strength were compared. As shown in FIG. 7, under a low magnetic field strength, the deformation ability of the ferrofluid droplet robots is the best; however, as the magnetic field strength increases, it becomes difficult for the ferrofluid droplet robots to remain intact. The maximum elongation length increased linearly as the magnetic field strength increased for the slimebot and liquid metal robots. Under equal magnetic field strength, the elongation length of the slime robot was greater than that of the magnetic liquid metal robot. In addition, we compared the maximum elongation lengths of ferrofluid droplet, magnetic liquid metal, and slime robots with equal volumes. The results demonstrate that the elongation of the slime robot was the largest when the three volumes were equal.

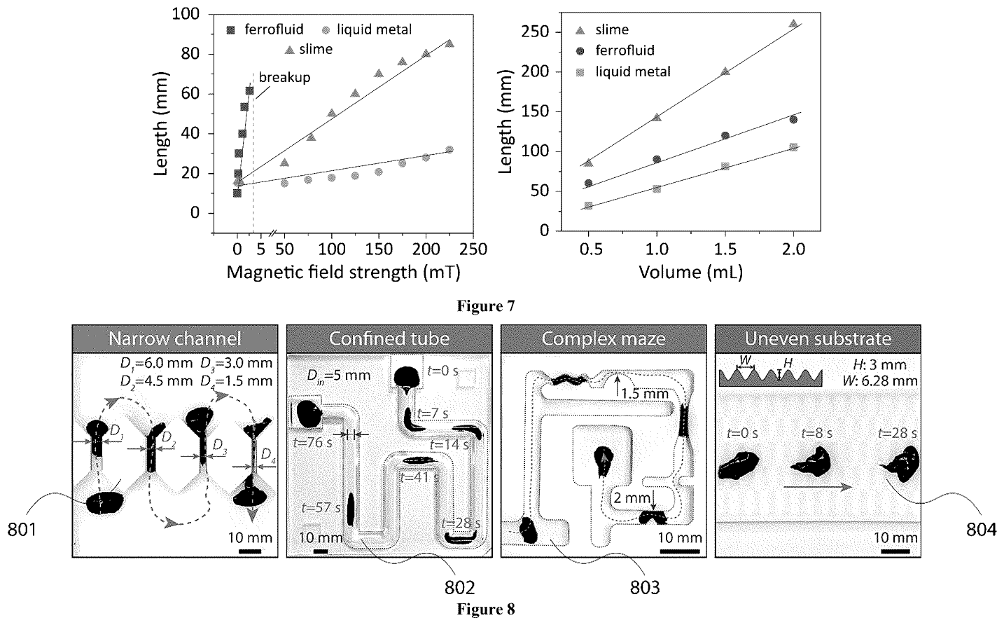

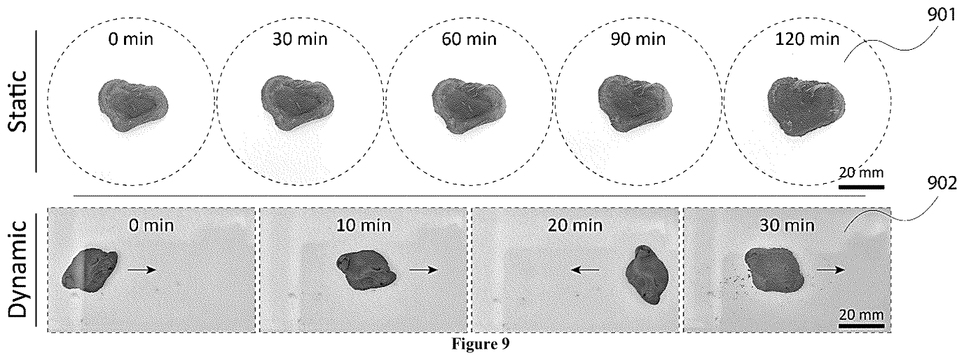

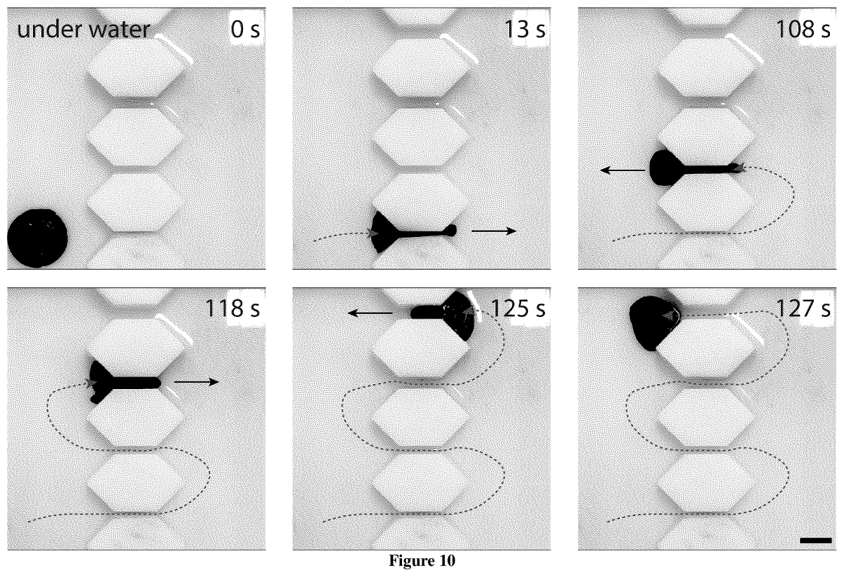

In embodiments, the passive and active deformation capabilities of magnetic slimebot may give them a remarkable advantage, not only for adapting to complex terrain environments but also for entering confined spaces in a controlled manner while maintaining their mobility and integrity. The shape-shifting nature allows the slimebot to adapt to changing external environments to satisfy the demands of multitasking. As illustrated in FIG. 8, under the control of a magnetic field, the slimebot can navigate freely through various terrains such as narrow channels 801, confined tubes 802, complex mazes 803, and uneven substrates 804. First, an array of channels with diameters of 6, 4.5, 3, and 1.5 mm were prepared to test the deformation ability of the magnetic slimebot. According to the experimental results, although it took a long time (approximately 180 s) for the magnetic slimebot to pass through the 1.5 mm diameter channel, eventually, the slimebot could successfully pass through each channel in turn. Subsequently, 1 mL magnetic slimebot can flow smoothly in a liquid-free tube with an inner diameter of 5 mm. Deformability allows the slimebot to negotiate the curved tube structure quickly and stretch its shape along the direction of movement within the tube. In addition, a maze with varied inner diameters (minimum gap: 1.5 mm) and complex branches was also prepared to demonstrate the deformability and controllability of the slimebot. Finally, slimebot can migrate over uneven terrain with a width of 6.28 mm and height of 3 mm. In addition to the demonstrated controlled deformation behavior of slimebot in air, it can also work stably under water environment 901, 902, and meet the needs of various tasks (FIG. 9 and FIG. 10). The magnetic slimebot can maneuver unobstructedly over multiple terrains by actively and passively changing its shape, dramatically reducing its damage to the surrounding environment, and expanding its application scenarios.

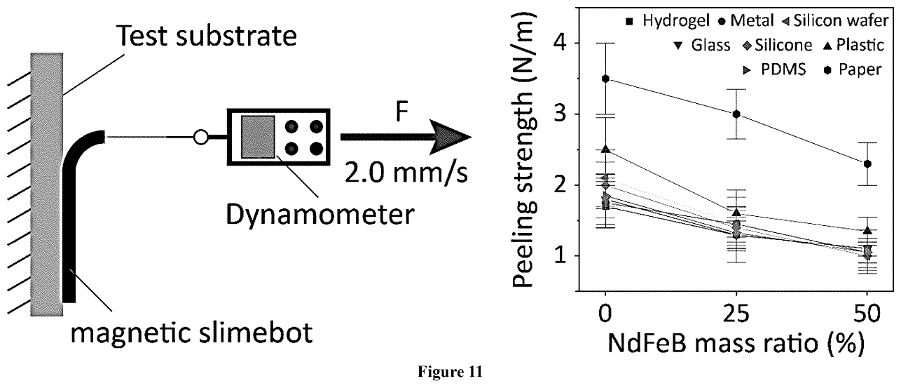

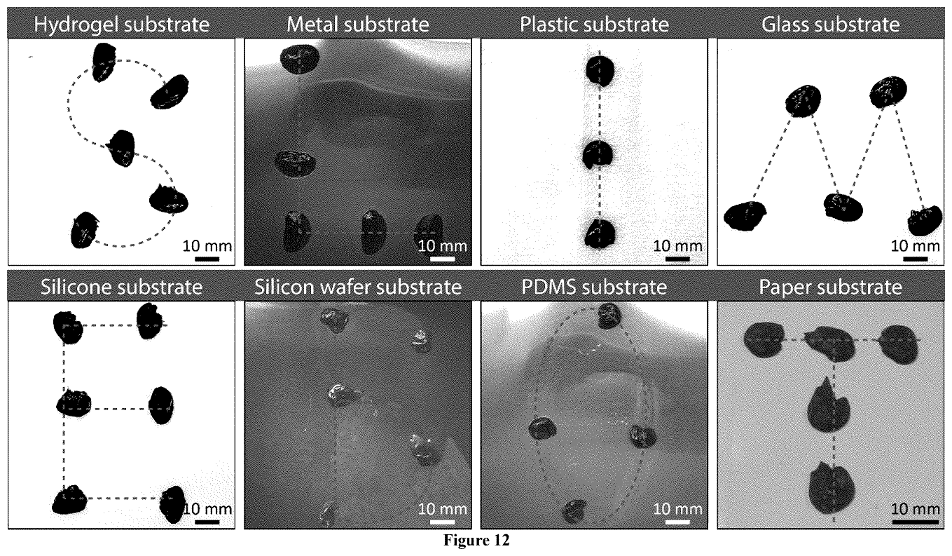

To further understand the adhesion properties of slimebot, the peeling strength between the slimebot and the substrate was investigated. As shown in FIG. 11, the experimental results demonstrate that paper has the highest bond strength that decreases with increasing magnetic particle content. This is mainly due to the better water absorption effect of the paper and the rough surface where the slimebot can diffuse into the micropores and be retained as a residue during peeling. The hydrogen bonding between the PVA molecular chains enhances adhesion during the tearing of the material when the bonding force of the hydrogen bond is greater than the van der Waals force. Furthermore, magnetic particles can decrease the slimebot adhesion properties because they prevent the hydroxyl groups in the PVA molecular chain from combining with water molecules. This adhesion property reduces the deformation rate and overall motion speed; however, the driving magnetic field can overcome it, preventing it from affecting the final deformation and reachable range. The disclosed magnetic slimebot can be adapted to a wide range of substrates. A total of eight commonly used substrates, including hydrogel, metal, plastic, glass, silica, silicon, polydimethylsiloxane, and paper substrates, and cut them into 10 cm×10 cm pieces were prepared. As illustrated in FIG. 12, when actuated by a permanent magnet, a 500 μL slimebot can follow the trajectory of “SLIMEBOT” on these substrates.

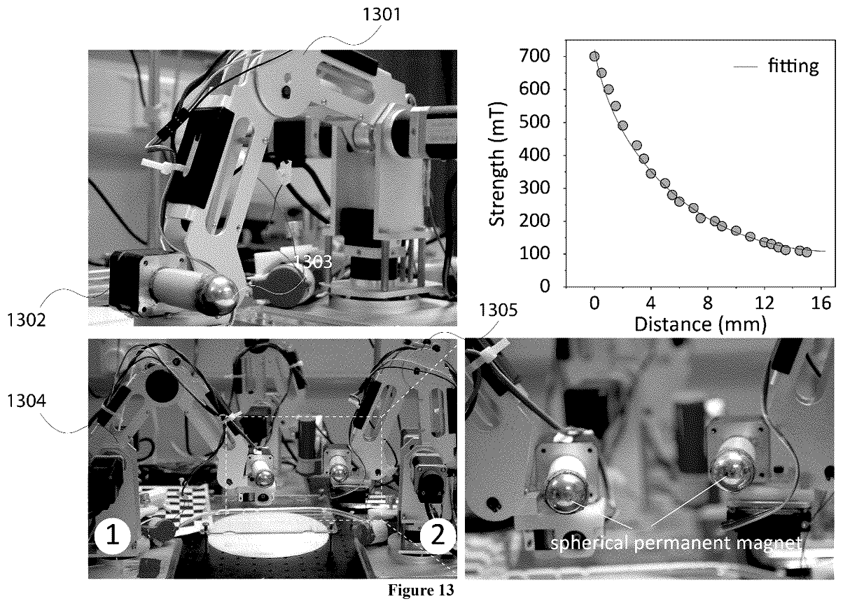

The magnetic drive system of the disclosed technology consists of a robotic arm 1301, a stepper motor 1302, and a spherical permanent magnet 1303 with a diameter of 20 mm. As shown in the FIG. 13, the 3-degree-of-freedom robotic arm is loaded with motor-driven permanent magnets, and the robotic arm can move to the targeted position autonomously encoded according to the task needs. Moreover, there is a step motor at the end of the robotic arm, and the motor can adjust the speed and direction of the permanent magnet on demand. Thus, the whole system can generate a directional gradient magnetic field and a non-uniform rotating magnetic field. The magnetic field intensity of the surface of the permanent magnet is about 700 mT, and the magnetic field intensity at 10 mm from the permanent magnet is about 200 mT. The magnetic field strength to drive the magnetic slime robot through complex terrain, grasping and transporting objects, is about 200 mT. In addition, the magnetic slime robot can be driven by cooperatively controlled two robotic arm systems.

The invention will be better understood by reference to the Experimental Details which follow, but those skilled in the art will readily appreciate that the specific experiments described are only for illustrative purpose and are not meant to limit the invention as described herein, which is defined by the claims that follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

### Example 1

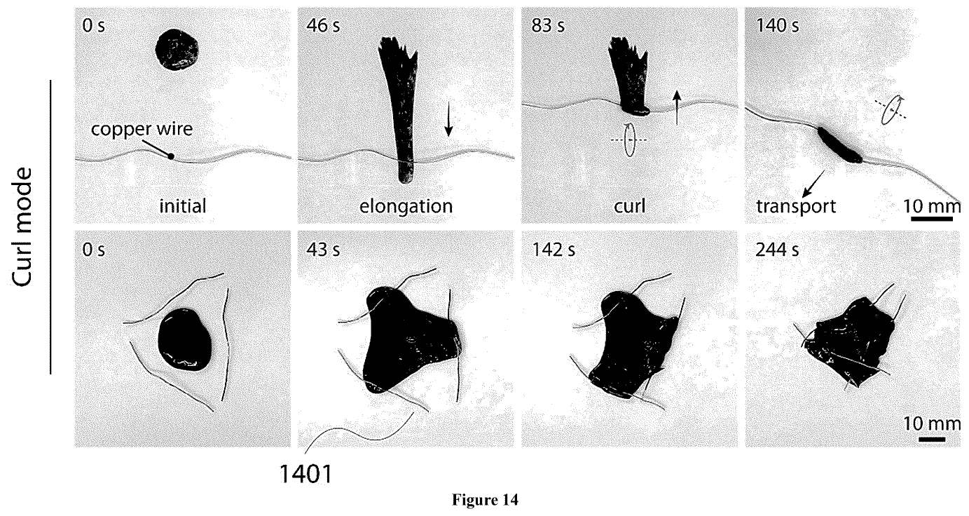

In embodiments, the magnetic slimebot can also utilize reconfigurability to achieve flexible manipulation. FIG. 14 (above) shows that slimebot can grasp copper wire 1401 using the curling mode after being elongated. At t=0 s, the magnetic slimebot actuated by the permanent external magnet began to stretch. After 46 s, the slimebot elongates to the bottom of the target object. During the elongation process, the magnetic particles in the slimebot are magnetized by a permanent external magnet and maintain a consistent magnetization direction. Because slimebot exhibits non-Newtonian behavior leading to limited dimensional stability, the orientation of internal magnetic particles with remanent magnetism does not change for a short time when the permanent external magnet is withdrawn. At this time, if a rotating magnetic field is applied, the elongated magnetic slimebot starts to curl and hook the target object (t=83 s). Finally, driven by the rotating magnetic field, the slimebot continues to curl until it eventually wraps the target object completely and can carry it for rolling motion (t=140 s). Furthermore, the magnetic slimebot can grasp multiple target objects simultaneously using its deformation characteristics, as shown in FIG. 14 (below). When the manipulated object is present in all three directions, the slimebot can extend its tentacles in three directions, such as an octopus arm (t=43 s). Thereafter, an external rotating magnetic field is applied in sequence, and the three tentacles of the slimebot begin to curl sequentially. Finally, the three target objects were grasped using the curl mode. The curl operation mode can help accomplish the grasping function for long-range restricted environmental species.

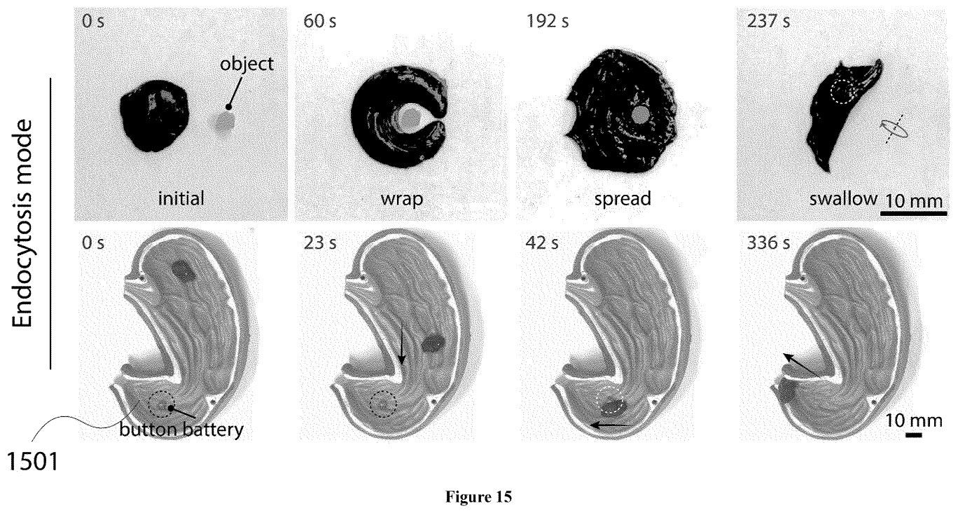

In embodiments, owing to its shape-shifting property, the slimebot can also grasp and transport objects through endocytosis. As illustrated in FIG. 15 (above), the slimebot can swallow the target object through wrapping, spreading, and curling, consecutively. At t=0 s, the magnetic slimebot begins to deform under the action of the bottom-ring-shaped permanent magnet. The circular slimebot gradually becomes C-shaped when the ring-shaped permanent magnet is tilted, and moving the permanent magnet can induce the slimebot to enclose the target object (t=60 s). Thereafter, the C-shaped slimebot becomes a ring when the ring-shaped permanent magnet is placed parallel to the operating surface. Subsequently, the permanent magnet was continuously moved outward in a reciprocal manner to spread the slimebot on a flat surface (t=192 s). As the slimebot expands, the permanent magnet magnetizes the magnetic particles in the slimebot. Finally, the slimebot curls under a rotating magnetic field and swallows the target object placed on top of it (t=237 s). When an object is swallowed by the slimebot, it is completely isolated from the external environment, which facilitates the capture of dangerous objects.

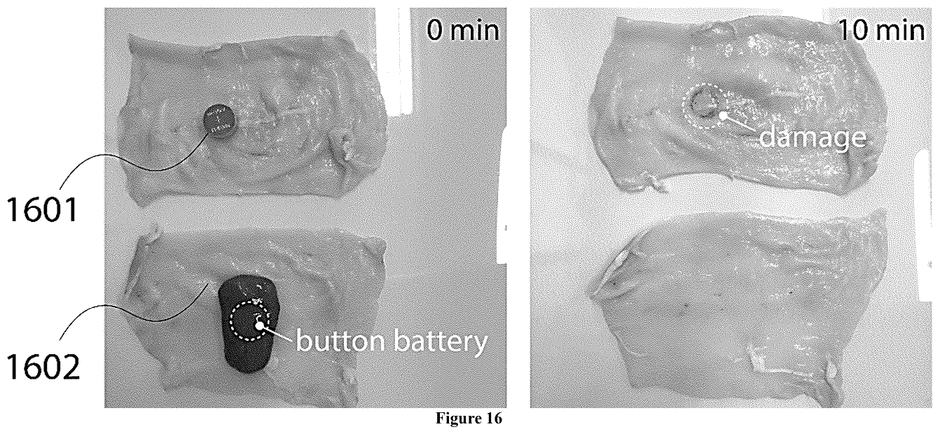

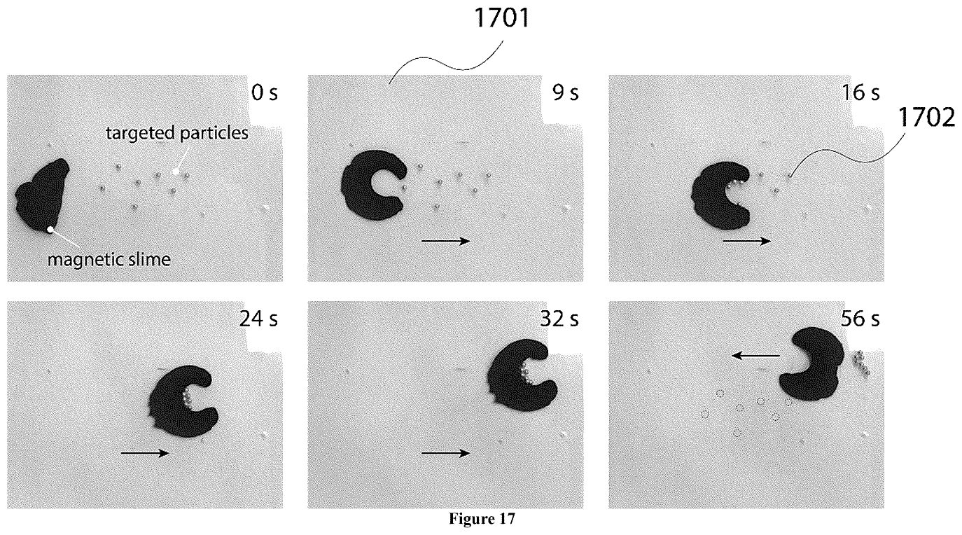

For example, magnetic slimebot can be used in clinical interventions for button battery ingestion, which seriously endangers the life of the patient. Human ingestion was simulated by sandwiching button batteries 1601 between the lining of the large intestine of a pig 1602. After 30 min, it caused severe damage to the lining of the intestine (FIG. 16). To reduce the risk of battery ingestion, magnetic slimebot is utilized and controlled by directing it to the injury site and thereafter to remove the stuck button battery through endocytosis (FIG. 15 (below)). A simulated stomach model 1501 with the inner lining filled with folds was prepared. When the magnetic slimebot enters the stomach interior, it can move along the uneven inner wall, driven by an external magnetic field (t=42 s). When the slimebot reaches the damage site, the button cell can be wrapped in the slimebot by covering and curling to prevent further discharge and damage to the stomach lining. The disclosed magnetic slime robot can also be used for clinical application of gallstone fragments, and the fragments can be taken out by spreading the package. The disclosed magnetic slimebot may also transform into a crescent shape underwater 1701 and accomplish the collection and transport of solid spherical particles 1702 (FIG. 17).

### Example 2

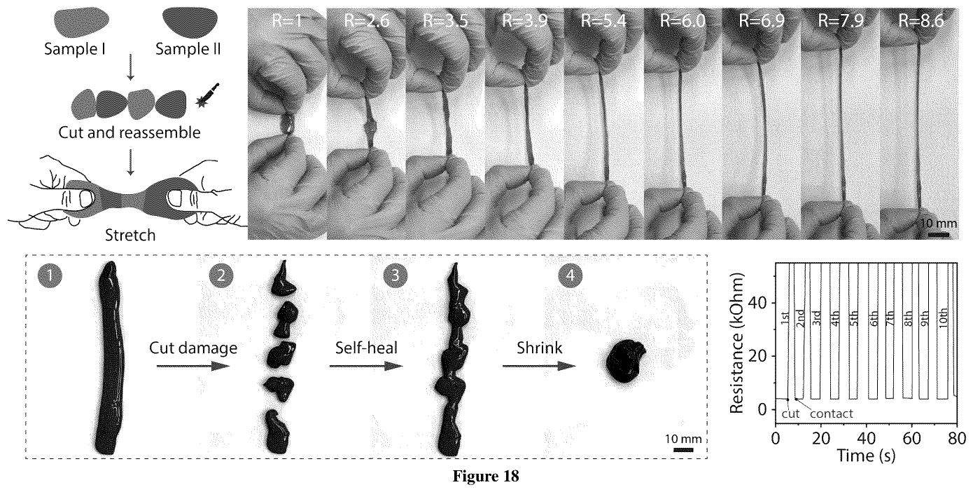

The non-Newtonian fluid behavior of slimebot, combined with the magnetization character of its internal magnetic particles, endows it with remarkable deformability and reconfigurability. The damage and recovery of hydrogen bonds between its internal tetrafunctional borate ions and —OH groups exhibit self-healing capabilities. This crosslinking was easily bound and dissociated dynamically at room temperature, thus exhibiting self-healing at room temperature. This occurs spontaneously without the help of external sources such as chemical reagents. Self-healing is mainly due to the sufficient mobility of the polymer chains within the slimebot and free tetrafunctional borate ions, allowing hydrogen bonds at the fracture interface to rapidly trigger the self-healing process in the absence of external stimuli. Two slime samples without the addition of magnetic particles were cut into four pieces and placed together to demonstrate their self-healing ability. The two samples were stained with green and blue dyes to distinguish the cut sites; thereafter, four small pieces of slime were joined together at intervals to begin healing. FIG. 18 illustrates that the interface at the cut site is immediately reconnected (less than 1 s). The healed slime is well connected, maintains excellent plasticity, and withstands major strains even after being stretched to 8.6 times the original length without damage to the reconnected parts. As demonstrated in FIG. 18, a long strip of magnetic slimebot can eventually be healed into a circular shape after being cut into multiple pieces. First, at room temperature, the striped slimebot is cut into five small pieces; thereafter, driven by a magnetic field, the five slimebots touch each other one by one, and finally, the magnetic slimebot completes the healing process.

Slimebot possesses electrical conductivity properties. Thereafter, the time of self-healing of the magnetic slimebot by measuring the resistance of the slimebot over time during the cutting-healing process. FIG. 18 shows repeated cut-repair ten times at the same position of the magnetic slimebot. An open circuit is formed once the magnetic slimebot is completely cut and the resistance becomes infinite. When the broken parts were combined, the resistance dropped rapidly and returned to near the initial value within 1 s. Magnetic slimebot has significant and reproducible electrical repair properties and exhibits excellent self-healing efficiency during each cut and repair process. Therefore, this self-healing ability may also cause electrical healing, that is, restored conductivity after the damage-healing cycle.

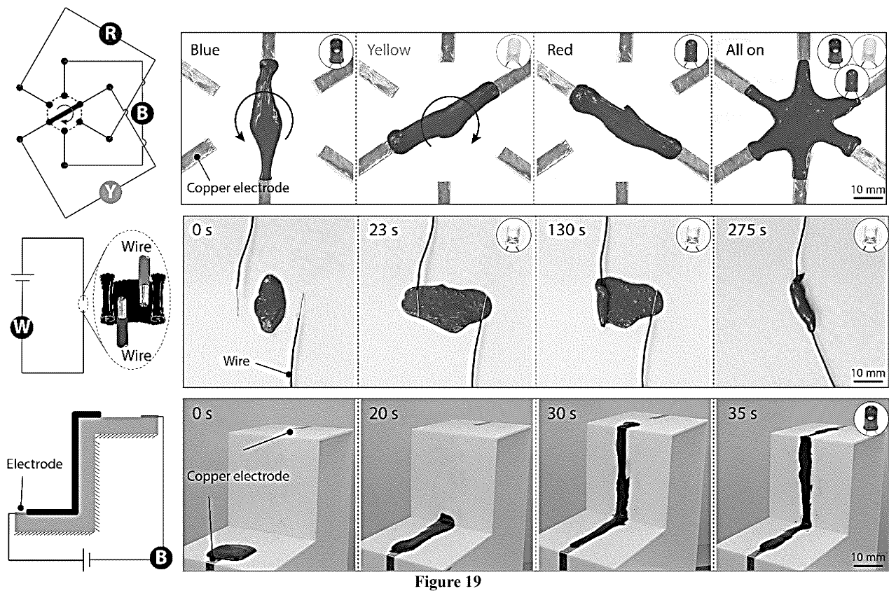

Self-healing and deformable conductive slimebots are promising tools for various electronic devices. For example, the electroconductibility of the magnetic slimebot allows it to act as a circuit switch, as shown in the schematic in FIG. 19. A three-way circuit is fabricated, and processing each circuit will cause the red, blue, and yellow LED bulbs to light up. In the initial state, the three LED bulbs were disconnected. Driven by an external magnetic field, the magnetic slimebot was controlled to light up the blue, yellow, and red LED bulbs in sequence. Interestingly, the slimebot can also transform into the shape of an octopus and turn on the three circuits simultaneously to light the three LED bulbs. In addition to acting as a circuit switch on a two-dimensional plane, slimebots can also be used to repair damaged circuits. Electronic devices may fail because of partial disconnection if they are corrupted by a long-term environment or are scratched by sharp objects. As illustrated in FIG. 19, the circuit repair process comprises three steps: stretching, spreading, and curling. The repaired circuit can function properly and light up the bulb. As shown in FIG. 19, the magnetic slimebots can achieve 3D open-circuit connections. The ability of the magnetic slime robot to repair the circuit can also be extended to the space station, where it is difficult for humans to perform circuit repair.

### Example 3

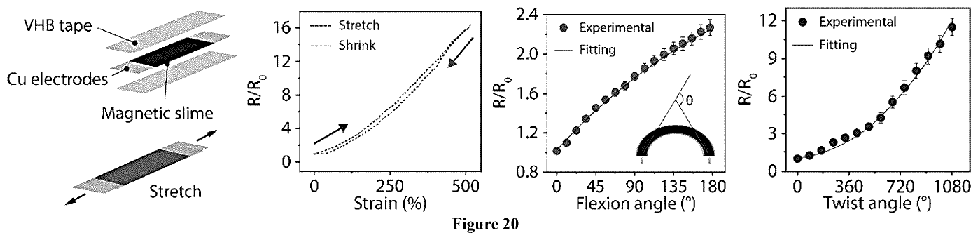

The deformation and self-healing capabilities of magnetic slimebot allow it to be used as a motion sensor adapted to bending and dynamic mechanical environments. Considering the patterns of human motion (stretching, bending, and twisting), the electromechanical properties can be characterized. First, the magnetic slimebot was encapsulated between two pieces of VHB tape and connected the two ends using copper electrodes (FIG. 20). The VHB tape can create a strong connection between the magnetic slimebot and the copper electrodes to ensure repeatability during the test and to avoid evaporation of water from the ion-conductive magnetic slimebot, which could alter the quality of the electromechanical signal. The relative resistance change versus strain, where the resistance increases with increasing strain. The relative resistance of the magnetic slimebot was 1600% at a strain of 500%, and this response was reproducible. In addition, a clear hysteresis exists within the large deformation (500%) stretch-release cycle. In both cases, the initial resistance of the slimebot completely recovered after its release from the strain. The response of the magnetic lime-based strain transducer to deformation with bending and twisting was thereafter tested. The change in resistance of the magnetic slimebot-based strain sensor as a function of the bending angle. The experimental results demonstrate that as the bending angle increased from 0° to 180°, the resistance increased from the original value to 220%. When the lime-based strain sensor is twisted, the variance in resistance obeys a parabolic equation for twist angles less than 540°. However, at larger torsion angles (over 540°), the magnetic slimebot separates from each other around the torsion point, and the resistance increases rapidly. After three turns (1080°), the resistance increased from its value in the untwisted state to 1200%. In conclusion, the magnetic slimebots can be modified into stable and repeatable piezoresistive strain sensors to maintain their operation in various mechanically demanding human body areas.

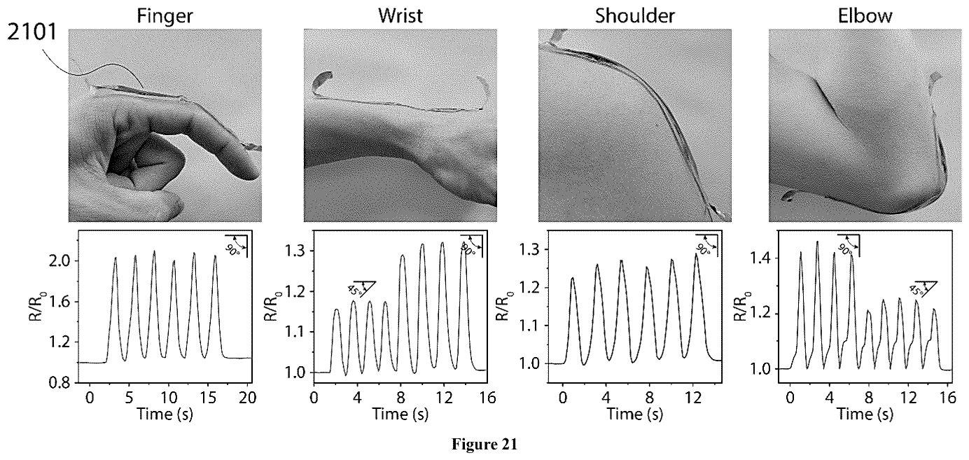

In addition, sensors are an essential component of soft robots. Therefore, the possibility of a slime robot acting as a sensor was explored. For example, magnetic slimebots encapsulated in VHB tape 2101 were applied directly to the skin of the human body to detect bending and extension behavior, such as fingers, wrists, shoulders, and elbows. As shown in FIG. 21, the variation in the resistance with respect to the bending angle of the index finger, wrist, shoulder, and elbow joints were monitored. When the index finger was repeatedly bent from the relaxed state (0°) to the bent state (90°) at a frequency of approximately 1 Hz, the slimebot resistance changes monitored by the impedance analyzer exhibited a fast and repeated response to the finger motion. To detect wrist flexion, the resistance evolution of the sensor was measured at 45° and 90° bending angles, respectively. Interestingly, the resistance of the slimebot-based sensor increases with increasing bending angle (approximately 1.15 at 45° and 1.35 at 90°), thus allowing differentiation between different bending angles of the wrist joint. The sensor can also measure shoulder and elbow movements of the body separately. The presented sensor signals exhibited good stability during the cyclic measurements. Magnetic slimebot can use external deformation to obtain signals of human motion, and in the future, it may also use deformation signals to infer the position or stiffness of the robot. Theoretically, the magnetic slime robot combines motion and sensing, and will have a wider range of application scenarios in the future. In conclusion, this deformable, electrically conductive magnetic slimebot can be used in various applications, including wearable devices and soft robots.

What is claimed is:

1. A composition, comprising:
a. 0.005-5 wt. % of a source of tetrafunctional borate ions;
b. a buffer for maintaining pH at 6.5 to 9.5;
c. 0.005-80 wt. % of magnetic particles; and
d. a polymeric glue having hydroxyl groups;
wherein said tetrafunctional borate ion, buffer and magnetic particles are crosslinked in said polymeric glue to form a non-Newtonian fluid composition.

2. The composition of claim 1, wherein said source of tetrafunctional borate ions comprises one or more selected from the group consisting of boric acid, sodium borate, disodium tetraborate, sodium tetraborate decahydrate and sodium tetraborate.

3. The composition of claim 1, wherein said buffer comprises deionized water or phosphate buffered saline.

4. The composition of claim 1, wherein said magnetic particles are:
a. metallic oxide particles;
b. NdFeB particles; or
c. coated with SiO₂.

5. The composition of claim 1, wherein polymeric glue is polyvinyl alcohol.

6. The composition of claim 5, wherein said polyvinyl alcohol comprises one or more selected from the group consisting of PVA 07-18, PVA 07-19, PVA 08-08 and PVA 08-18.

7. A slimebot comprising said composition of claim 1.

8. A system, comprising:
a. one or more said slimebot of claim 7; and
b. one or more magnetic field generator.

9. The system of claim 8, wherein said one or more magnetic field generator comprises a robotic arm, a stepper motor and a permanent magnet, wherein said stepper motor is located at the end of said robotic arm and adjusts speed and direction of said permanent magnet.

10. The system of claim 9, wherein said permanent magnet is a spherical magnet.

11. A sensor comprising said composition of claim 1, wherein said sensor measures changes in electrical properties of said composition in response to one or more mechanical stimulus.

12. The sensor of claim 11, wherein said electrical properties comprise one or more of impedance or resistance.

13. The sensor of claim 11, wherein said one or more mechanical stimulus comprise one or more of stretching, bending or twisting.

14. A device comprising the composition of claim 1, wherein said composition is used for controlling electrical conductivity in a part of an electrical circuit.

15. The device of claim 14, wherein said part is:
a. an electrical switch or a resistor; or
b. a damaged part.

16. A method of using said composition of claim 1 to achieve a function, comprising the steps of:
a. providing said composition to a location where said function is to be achieved;
b. subjecting said composition to a magnetic field; and
c. controlling said magnetic field to direct movement of said composition.

17. The method of claim 16, wherein said function comprises one or more of:
a. removing biofilms;
b. cleaning of ultra-precise instruments;
c. repairing electrical circuits; or
d. retrieving one or more objects in a cavity.

18. The method of claim 17, wherein said one or more objects is an ingested foreign body and said cavity is a gastrointestinal tract.

19. The method of claim 16, wherein said movement comprises grasping, wrapping, spreading, curling or endocytosis.

20. The method of claim 16, wherein said location is:
a. an environment with or without gravity; or
b. an environment with or without radiation.
